(19) United States
(12) Patent Application Publication
(10) Pub. No.: US 2023/0147258 A1
(43) Pub. Date: May 11, 2023

(54) METHOD FOR MANAGING TRAVEL, TRAVEL MANAGEMENT APPARATUS, AND NON-TRANSITORY COMPUTER-READABLE RECORDING MEDIUM

(71) Applicant: SUMITOMO ELECTRIC INDUSTRIES, LTD., Osaka-shi, Osaka (JP)

(72) Inventor: Shigeki NISHIMURA, Osaka-shi (JP)

(73) Assignee: SUMITOMO ELECTRIC INDUSTRIES, LTD., Osaka-shi, Osaka (JP)

(21) Appl. No.: 17/918,421

(22) PCT Filed: Apr. 5, 2021
(86) PCT No.: PCT/JP2021/014427

§ 371 Date: Oct. 12, 2022

(30) Foreign Application Priority Data
May 7, 2020 (JP) 2020-081815

(51) Int. Cl. G01C 21/36; G01C 21/34

(52) U.S. Cl. CPC G01C 21/3617; G01C 21/3476; G01C 21/3691

(57) ABSTRACT

A method for managing travel includes: acquiring travel plan data of the vehicle and travel record data including a travel record of the vehicle traveling on a travel route included in the travel plan data; and generating scheduled and actual arrival time difference data indicating a first scheduled and actual time difference that is a difference between a scheduled time at which the vehicle arrives at a stopover point on the travel route and a time at which the vehicle arrives at the stopover point or a difference between a scheduled time at which the vehicle arrives at a destination point on the travel route and a time at which the vehicle arrives at the destination point, based on the travel plan data and the travel record data.

### TECHNICAL FIELD

The present disclosure relates to a method for managing travel, a travel management apparatus, and a non-transitory computer-readable recording medium.

This application claims priority based on Japanese Patent Application No. 2020-081815 filed on May 7, 2020, and the entire contents of the Japanese patent application are incorporated herein by reference.

### BACKGROUND ART

PTL1 discloses a technique related to delivery support that enables delivery work to be performed within an allowable time. In the PTL 1, a management terminal apparatus is used for delivery support. The management terminal displays the delay time of delivery (see FIG. 23 of PTL 1). The delay time of delivery is obtained as a time difference between the scheduled delivery time and the actual delivery time.

### CITATION LIST

### Patent Literature

PTL 1: JP2018-73032A

PTL2: JPH10-232991A

### SUMMARY OF INVENTION

One aspect of the present disclosure is a method for managing travel of a vehicle. The method of the present disclosure includes acquiring, by a processing apparatus, travel plan data of the vehicle, and travel record data including a travel record of the vehicle having traveled along a travel route included in the travel plan data, generating, by the processing apparatus, scheduled and actual arrival time difference data indicating a first scheduled and actual time difference, based on the travel plan data and the travel record data, the first scheduled and actual time difference being a difference between a scheduled time at which the vehicle arrives at a stopover points on the travel route and a time at which the vehicle actually arrives at the stopover points or a difference between a scheduled time at which the vehicle arrives at a destination point on the travel route and a time at which the vehicle actually arrives at the destination point, generating, by the processing apparatus, scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point or a difference between a scheduled time at which the vehicle departs from the stopover point and a time at which the vehicle actually departs from the stopover point, and generating display data including the scheduled and actual arrival time difference data and the scheduled and actual departure time difference data. The travel plan data includes scheduled times at which the vehicle departs from the starting point and the stopover point, and scheduled times at which the vehicle arrives at the stopover points and the destination point, and the travel record data includes times at which the vehicle actually departs from the starting point and the stopover point, and times at which the vehicle actually arrives at the stopover point and the destination point.

Another aspect of the present disclosure is an apparatus for managing travel of a vehicle. The apparatus of the present disclosure includes a memory, and a processor configured to read a computer program stored in the memory and execute a method for managing travel of the vehicle. The method includes acquiring travel plan data of the vehicle, and travel record data including a travel record of the vehicle having traveled along a travel route included in the travel plan data, generating scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point, or a difference between a scheduled time at which the vehicle arrives at a destination point on the travel route and a time at which the vehicle actually arrives at the destination point, generating scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point, or a difference between a scheduled time at which the vehicle departs from the stopover point and a time at which the vehicle actually departs from the stopover point, and generating display data including the scheduled and actual arrival time difference data and the scheduled and actual departure time difference data. The travel plan data includes scheduled times at which the vehicle departs from the starting point and the stopover point, and scheduled times at which the vehicle arrives at the stopover point and the destination point, and the travel record data includes times at which the vehicle actually departs from the starting point and the stopover points, and times at which the vehicle actually arrives at the stopover point and the destination point.

Another aspect of the present disclosure is a non-transitory computer-readable recording medium storing a computer program. The computer program of the present disclosure causes a computer to execute an analysis process, the analysis process includes acquiring travel plan data of a vehicle, and travel record data including a travel record of the vehicle having traveled along a travel route included in the travel plan data, generating scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point, or a difference between a scheduled time at which the vehicle arrives at a destination point on the travel route and a time at which the vehicle actually arrives at the destination point, generating scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point, or a difference between a scheduled time at which the vehicle departs from the stopover point and a time at which the vehicle actually departs from the stopover point, and generating display data including the scheduled and actual arrival time difference data and the scheduled and actual departure time difference data. The travel plan data includes scheduled times at which the vehicle departs from the starting point and the stopover point, and scheduled times at which the vehicle arrives at the stopover point and the destination point, and the travel record data includes times at which the vehicle actually departs from the starting point and the stopover point, and times at which the vehicle actually arrives at the stopover point and the destination point.

### BRIEF DESCRIPTION OF DRAWINGS

FIG. 1 is a configuration diagram of a travel management system including a travel management apparatus.

FIG. 2 is a data structure diagram showing travel plan data.

FIG. 3 is a data structure diagram showing travel record data.

FIG. 4 is a flow chart of the scheduled and actual time difference analysis process.

FIG. 5 is a data structure diagram of scheduled and actual arrival time difference data.

FIG. 6 is a structure diagram of an evaluation table.

FIG. 7 is a data structure diagram of scheduled and actual departure time difference data.

FIG. 8 is a data structure diagram of scheduled and actual movement time difference data.

FIG. 9 is a schematic diagram of an exemplary screen.

FIG. 10 is a schematic diagram of an exemplary screen.

FIG. 11 is a schematic diagram of an exemplary screen.

FIG. 12 is a schematic diagram of an exemplary screen.

FIG. 13 is a schematic diagram of an exemplary screen.

FIG. 14 is a schematic diagram of a modified example of the link.

### DESCRIPTION OF EMBODIMENTS

### Problems to be Solved by Present Disclosure

When making a new travel plan for a vehicle, the cause of the delay that has actually occurred in the past should be considered. If the cause of the delay can be easily grasped, it is useful for analyzing the delay.

However, in the PTL 1, the time set as a schedule is only a single time called “scheduled delivery time”. The display of the delay time such as PTL1 is useful for determining whether or not delivery has been performed as scheduled, but is not necessarily effective for grasping the cause of the delay. For example, it is difficult to determine whether the cause of the delay is during movement between delivery destinations or during work at a delivery destination from the display of the delay time such as PTL1.

The delay that occurs during travel between delivery destinations is, for example, a delay due to traffic congestion. The delay occurring during the work at the delivery destination is, for example, a delay due to prolonged work such as unloading after arriving at the delivery destination.

It would be desirable to make analysis of such delays easier.

### Advantageous Effects of Present Disclosure

The present disclosure facilitates the analysis of delay.

### Description of Embodiments of Present Disclosure

(1) A method for managing travel of a vehicle according to an embodiment includes acquiring, by a processing apparatus, travel plan data of the vehicle, and travel record data including a travel record of the vehicle having traveled along a travel route included in the travel plan data, generating, by the processing apparatus, scheduled and actual arrival time difference data indicating a first scheduled and actual time difference, based on the travel plan data and the travel record data, the first scheduled and actual time difference being a difference between a scheduled time at which the vehicle arrives at stopover point on the travel route and a time at which the vehicle actually arrives at the stopover point or a difference between a scheduled time at which the vehicle arrives at a destination point on the travel route and a time at which the vehicle actually arrives at the destination point, generating, by the processing apparatus, scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point or a difference between a scheduled time at which the vehicle departs from the stopover point and a time at which the vehicle actually departs from the stopover point, and generating display data including the scheduled and actual arrival time difference data and the scheduled and actual departure time difference data. The travel plan data includes scheduled times at which the vehicle departs from the starting point and the stopover point, and scheduled times at which the vehicle arrives at stopover points and the destination point, and the travel record data includes times at which the vehicle actually departs from the starting point and the stopover point, and times at which the vehicle actually arrives at the stopover point and the destination point. In this case, since the scheduled and actual arrival time difference data and the scheduled and actual departure time difference data are displayed, it is easy to analyze the delay.

(2) The scheduled and actual arrival time difference data includes a first graphical image representing the first scheduled and actual time difference without using characters or numbers. The method for managing travel according to the embodiment may include displaying the first graphical image on a screen of a display device. In this case, the scheduled and actual arrival time difference can be visually grasped.

(3) The scheduled and actual departure time difference data includes a second graphical image representing the second scheduled and actual time difference without using characters or numbers. The method for managing travel according to the embodiment may include displaying the second graphical image on a screen of a display device. In this case, the scheduled and actual departure time difference can be visually grasped.

(4) When the first scheduled and actual time difference is a difference between a scheduled time at which the vehicle arrives at the stopover point and a time at which the vehicle actually arrives at the stopover point, the first graphical image is displayed in an area of the screen, the area of the screen showing the stopover points, and when the first scheduled and actual time difference is a difference between a scheduled time at which the vehicle arrives at the destination point and a time at which the vehicle actually arrives at the destination point, the first graphical image may be displayed in an area of the screen, the area of the screen showing the destination point. In this case, the correspondence between the first scheduled and actual time difference at the stopover point and the destination point becomes clear, and the analysis of the delay becomes easy.

(5) When the second scheduled and actual time difference is a difference between a scheduled time at which the vehicle departs from the starting point and a time at which the vehicle actually departs from the starting point, the second graphical image may be displayed in an area of the screen, the area of the screen showing the starting point, and when the second scheduled and actual time difference is a difference between a scheduled time at which the vehicle departs from the stopover point and a time at which the vehicle actually departs from the stopover point, the second graphical image is displayed in an area of the screen, the area of the screen showing the stopover points. In this case, the correspondence between the second scheduled and actual time difference at the starting point and the stopover point becomes clear, and the analysis of the delay becomes easy.

(6) The screen may show a map including the travel route of the vehicle. In this case, the delay can be analyzed on the map.

(7) The display data may further include scheduled and actual movement time difference data indicating a scheduled and actual movement time difference, the scheduled and actual movement time difference being a difference between a scheduled time taken for the vehicle to move between two points among the starting point, one or more stopover points on the travel route, and the destination point along the travel route and a time taken for the vehicle to actually move between the two points along the travel route. In this case, it is possible to analyze the delay including the scheduled and actual movement time difference.

(8) A section between the two points is divided into a plurality of subsections, and the display data may further include, for each of the subsections, data indicating a difference between a scheduled time taken for the vehicle to move through the subsection along the travel route and a time taken for the vehicle to actually move through the subsection along the travel route. In this case, a detailed analysis of the scheduled and actual movement time difference is possible.

(9) The method for managing travel according to the embodiment may further include transmitting, by the processing apparatus, factor data to the display device, the factor data indicating a factor that causes the first scheduled and actual time difference or the second scheduled and actual time difference. In this case, a factor can be included in the analysis.

(10) The method for managing travel according to the embodiment may further include receiving, by the processing apparatus, a designation of a time included in a time slot during which the vehicle travels, and transmitting, by the processing apparatus, factor data to the display device, the factor data indicating a factor that causes the scheduled and actual movement time difference at the designated time. In this case, even when the factor varies with time, the factor at the designation time can be displayed.

(11) An apparatus for managing travel of a vehicle according to an embodiment includes a memory, and a processor configured to read a computer program stored in the memory and execute a method for managing travel of the vehicle. The method includes acquiring travel plan data of the vehicle, and travel record data including a travel record of the vehicle having traveled along a travel route included in the travel plan data, generating scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point, or a difference between a scheduled time at which the vehicle arrives at a destination point on the travel route and a time at which the vehicle actually arrives at the destination point, generating scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point, or a difference between a scheduled time at which the vehicle departs from the stopover point and a time at which the vehicle actually departs from the stopover point, and generating display data including the scheduled and actual arrival time difference data and the scheduled and actual departure time difference data. The travel plan data includes scheduled times at which the vehicle departs from the starting point and the stopover point, and scheduled times at which the vehicle arrives at the stopover point and the destination point. The travel record data includes times at which the vehicle actually departs from the starting point and the stopover point, and times at which the vehicle actually arrives at the stopover point and the destination point.

(12) A non-transitory computer-readable recording medium storing a computer program according to an embodiment for causing a computer to execute an analysis process. The analysis process includes acquiring travel plan data of a vehicle, and travel record data including a travel record of the vehicle having traveled along a travel route included in the travel plan data, generating scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point, or a difference between a scheduled time at which the vehicle arrives at a destination point on the travel route and a time at which the vehicle actually arrives at the destination point, generating scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point, or a difference between a scheduled time at which the vehicle departs from the stopover point and a time at which the vehicle actually departs from the stopover point, and generating display data including the scheduled and actual arrival time difference data and the scheduled and actual departure time difference data. The travel plan data includes scheduled times at which the vehicle departs from the starting point and the stopover point, and scheduled times at which the vehicle arrives at the stopover point and the destination point, and the travel record data includes times at which the vehicle actually departs from the starting point and the stopover point, and times at which the vehicle actually arrives at the stopover point and the destination point. The computer program is stored in a computer-readable, non-transitory storage medium.

### Details of Embodiments of Present Disclosure

Hereinafter, embodiments of the present disclosure will be described in detail with reference to the drawings. It should be noted that the embodiments described below each show a specific example of the present disclosure. Numerical values, shapes, constituent elements, arrangement positions and connection forms of the constituent elements, steps, the order of the steps, and the like shown in the following embodiments are examples, and are not intended to limit the present invention. The invention is defined by the claims. At least a part of the embodiments described below may be arbitrarily combined.

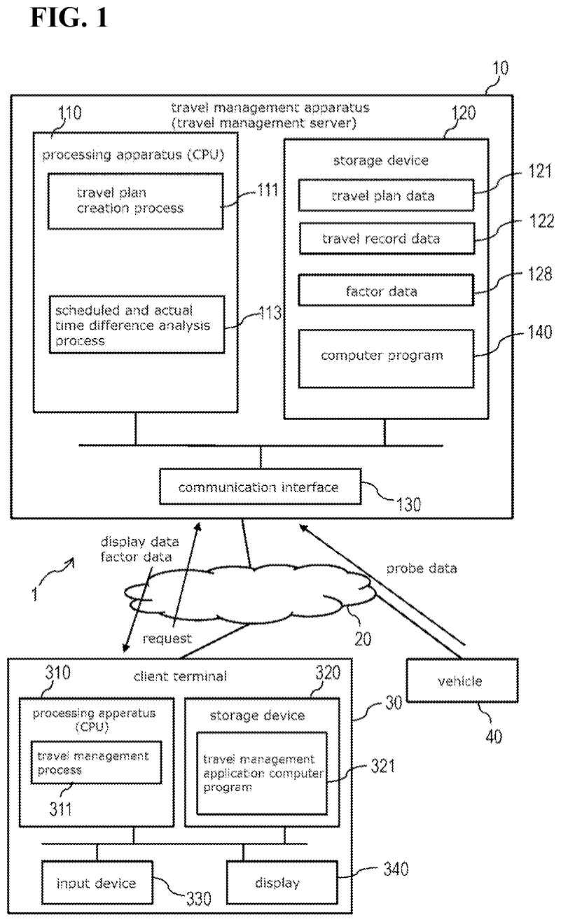

FIG. 1 shows a travel management system 1 according to an embodiment. Travel management system 1 includes a travel management apparatus 10 connected to a network 20 such as the Internet. Travel management apparatus 10 is, for example, a server computer on network 20. That is, in the embodiment, travel management apparatus 10 is a travel management server. Travel management system 1 includes a client terminal 30 connected to travel management apparatus 10 via network 20. Client terminal 30 is used by, for example, a driver of a vehicle 40 or other users. The other user is, for example, a vehicle operation manager.

Client terminal 30 is configured by a computer including a processing apparatus 310 and a storage device 320. Client terminal 30 may be, for example, a mobile terminal such as a laptop computer, a tablet, or a smartphone. Client terminal 30 can communicate with travel management apparatus 10 via a network.

Processing apparatus 310 is connected to storage device 320. Processing apparatus 310 is, for example, a CPU. Storage device 320 includes, for example, a primary storage device and a secondary storage device. The primary storage device is, for example, a RAM. The secondary storage device is, for example, a hard disk drive (HDD) or a solid state drive (SSD). In this specification, the CPU may be referred to as a processor, and storage device 320 may be referred to as a memory.

A travel management application computer program 321 for operating a computer as client terminal 30 is stored in storage device 320. Travel management application computer program 321 is configured, for example, to cause client terminal 30 to execute a travel management process 311 associated with travel management apparatus 10. The computer executing travel management process 311 operates as client terminal 30 shown in FIG. 1.

Processing apparatus 310 reads out travel management application computer program 321 from storage device 320 and executes it. Travel management application computer program 321 includes code for causing a computer to execute travel management process 311.

Client terminal 30 includes an input device 330 for user input and a display 340. Input device 330 is, for example, a keyboard, a mouse, or a touch panel.

Travel management apparatus 10 according to the embodiment is used, for example, for travel management of vehicle 40 for package delivery. Vehicle 40 may be used for delivery of a package or transportation of a person such as picking a person up. Travel management apparatus 10 is used to analyze a travel plan and a travel record of vehicle 40. In the analysis, a scheduled and actual time difference that is a difference between the travel plan and the travel record of vehicle 40 is obtained. Travel management apparatus 10 provides an analysis result of the travel plan and the travel record of the vehicle to client terminal 30 in response to a request from client terminal 30. The analysis result provided to client terminal 30 includes a scheduled and actual time difference that is a difference between the travel plan and the travel record. The analysis result including the scheduled and actual time difference is displayed on display 340 of client terminal 30. Client terminal 30 including display 340 functions as a display device that displays the scheduled and actual time difference and the like.

Travel management apparatus 10 is configured by a computer including a processing apparatus 110 and a storage device 120. Processing apparatus 110 is connected to storage device 120. Processing apparatus 110 is, for example, a CPU. Storage device 120 includes, for example, a primary storage device and a secondary storage device. The primary storage device is, for example, a RAM. The secondary storage device is, for example, a hard disk drive (HDD) or a solid state drive (SSD). In the present specification, storage device 120 may be referred to as a memory.

Storage device 120 stores a computer program 140 for causing a computer to operate as travel management apparatus 10. Computer program 140 is configured to cause processing apparatus 110 to execute, for example, a travel plan creation process 111 and a scheduled and actual time difference analysis process 113. The computer executing travel plan creation process 111 and scheduled and actual time difference analysis process 113 operates as travel management apparatus 10 shown in FIG. 1.

Processing apparatus 110 reads out computer program 140 from storage device 120 and executes it. Computer program 140 includes code for causing the computer to execute travel plan creation process 111 and code for causing the computer to execute scheduled and actual time difference analysis process 113.

The computer that operates as travel management apparatus 10 includes a communication interface 130. Communication interface 130 is used for travel management apparatus 10 to communicate with other computers such as client terminal 30 via network 20. Travel management apparatus 10 can acquire data from vehicle 40 via communication interface 130. The data acquired from vehicle 40 is, for example, probe data. The probe data includes, for example, the position and the speed of vehicle 40 at each time. The probe data is used to generate a travel record data 122 according to the embodiment.

Storage device 120 may store a travel plan data 121 and travel record data 122. Travel plan data 121 indicates, for example, a delivery plan of a package to be delivered by vehicle 40. Travel record data 122 indicates, for example, a delivery record of a package delivered by vehicle 40.

The delivery plan is, for example, a travel plan in which vehicle 40 returns from a vehicle base (starting point S) that is a base of delivery to a vehicle base (destination point D) via one or more stopover points P1, P2, and P3 that are delivery destinations. Travel plan data 121 is data indicating such a travel plan. In the travel plan, a starting point S may be different from a destination point D.

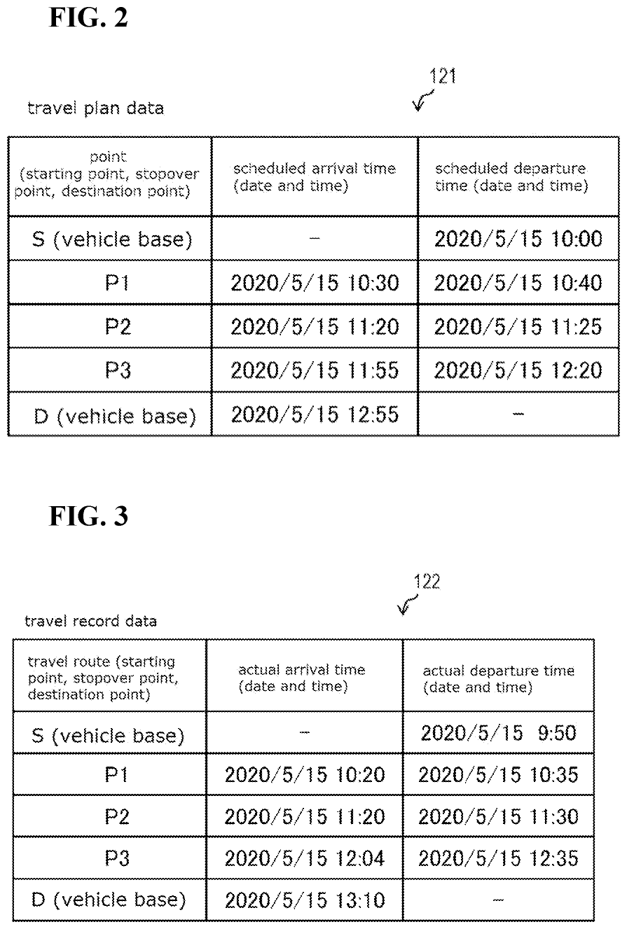

As shown in FIG. 2, travel plan data 121 includes starting point S, a first point P1, a second point P2, a third point P3, and destination point D included in the travel plan, a scheduled arrival time at each point, and a scheduled departure time at each point. As an example, in travel plan data 121 of FIG. 2, vehicle 40 is scheduled to depart from starting point S, which is a vehicle base, at 10:00 on May 15, 2020. Vehicle 40 is scheduled to arrive at first point P1, which is the first delivery destination, at 10:30 on the same day and depart at 10:40. Vehicle 40 is scheduled to arrive at second point P2, which is the second delivery destination, at 11:20 on the same day and depart at 11:25. Vehicle 40 is scheduled to arrive at third point P3, which is a third delivery destination, at 11:55 on the same day and depart at 12:20. Vehicle 40 is scheduled to arrive at destination point D, which is the vehicle base, at 12:55 on the same day.

Travel plan data 121 is generated, for example, by executing a vehicle operation plan creation method described in PTL2 in travel management apparatus 10. Further, travel plan data 121 may be generated by another computer for generating a travel plan. In this case, travel management apparatus 10 acquires travel plan data 121 from the other computer and stores it in storage device 120. Travel plan data 121 may be generated by a user such as a driver or a vehicle operation manager inputting a travel plan in client terminal 30. In this case, travel management apparatus 10 acquires travel plan data 121 from client terminal 30, and stores it in storage device 120.

The delivery record indicates a travel result of vehicle 40 in a case where vehicle 40 performs delivery according to the travel plan. The delivery record is, for example, a travel record until vehicle 40 returns to the vehicle base (destination point D) via first point P1, second point P2, and third point P3 which are delivery destinations from the vehicle base (starting point S) which is a base of delivery. Travel record data 122 is data indicating such a travel record. The travel record is usually different from the travel plan and has a difference with respect to the travel plan.

As shown in FIG. 3, travel record data 122 includes starting point S, first point P1, second point P2, third point P3, and destination point D included in an actual travel route, an actual arrival time at each point, and an actual departure time at each point. As an example, in travel record data 122 of FIG. 3, vehicle 40 departs from starting point S, which is a vehicle base, at 9:50 on May 15, 2020. Vehicle 40 arrived at first point P1, which is the first delivery destination, at 10:20 on the same day, and departed at 10:35. Vehicle 40 arrived at second point P2, which is the second delivery destination, at 11:20 on the same day, and departed at 11:30. Vehicle 40 arrived at third point P3, which is the third delivery destination, at 12:04 on the same day, and departed at 12:35. Vehicle 40 arrived at destination point D, which is the vehicle base, at 13:10 on the same day.

Travel record data 122 is generated by travel management apparatus 10 based on, for example, probe data transmitted from vehicle 40. Travel record data 122 may be generated by a user such as a driver inputting a travel record in client terminal 30. In this case, travel management apparatus 10 acquires travel record data 122 from client terminal 30, and stores it in storage device 120.

Travel management apparatus 10 may acquire travel plan data 121 and travel record data 122 in advance prior to the analysis, or may acquire them from client terminal 30 when an analysis request is received from client terminal 30.

Storage device 120 may store a factor data 128 as shown in FIG. 1. The factor data 128 is information indicating a factor that affects the travel record of vehicle 40. The factors that affect the travel record of vehicle 40 are, for example, traffic information such as traffic jam information, weather information, disaster information such as flood damage and earthquake, and information on a delivery method of a package at a stopover point that is a delivery destination.

Factors that affect the travel record include a factor that affects a travel time between points and a factor that affects a stay time at a point. Factors that affect the travel time between locations are, for example, congestion or weather. A factor that affects the stay time at a point is, for example, a delivery method of a package. The package delivery method includes, for example, Free on truck and Delivered at place. In the case of Free on truck, the stay time at the delivery destination is relatively short, and in the case of Delivered at place, the stay time at the delivery destination may be very long in some cases.

Factor data 128 may be generated by travel management apparatus 10 or may be generated by a computer other than travel management apparatus 10. When factor data 128 is generated by another computer, travel management apparatus 10 acquires factor data 128 from the other computer and stores it in storage device 120. Factor data 128 may be generated by a user such as a driver or a vehicle operation manager inputting factor data in client terminal 30. In this case, travel management apparatus 10 acquires factor data 128 from client terminal 30, and stores it in storage device 120.

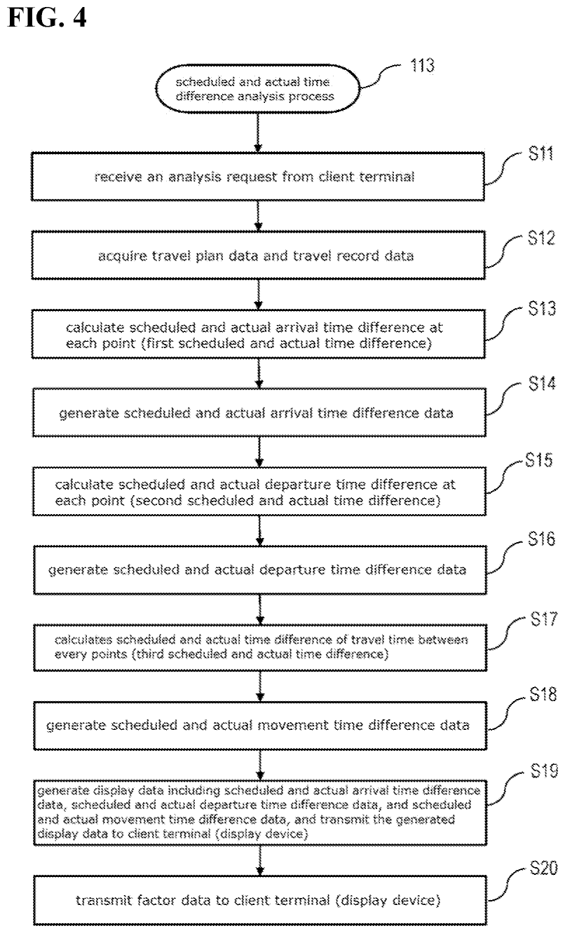

FIG. 4 shows an example procedure of scheduled and actual time difference analysis process 113 performed by processing apparatus 110 of travel management apparatus 10. In step S11, processing apparatus 110 receives an analysis request from client terminal 30. In step S12, processing apparatus 110 that has received the analyzing request acquires travel plan data 121 and travel record data 122 from another computer or client terminal 30, and stores them in storage device 120. In step S12, processing apparatus 110 may acquire travel plan data 121 and travel record data 122 stored in advance in storage device 120 from storage device 120.

In step S13, processing apparatus 110 calculates a first scheduled and actual time difference that is a scheduled and actual arrival time difference at first point P1, second point P2, third point P3, and destination point D included in the travel plan of vehicle 40. In step S14, processing apparatus 110 generates a scheduled and actual arrival time difference data 123 indicating the calculated first scheduled and actual time difference.

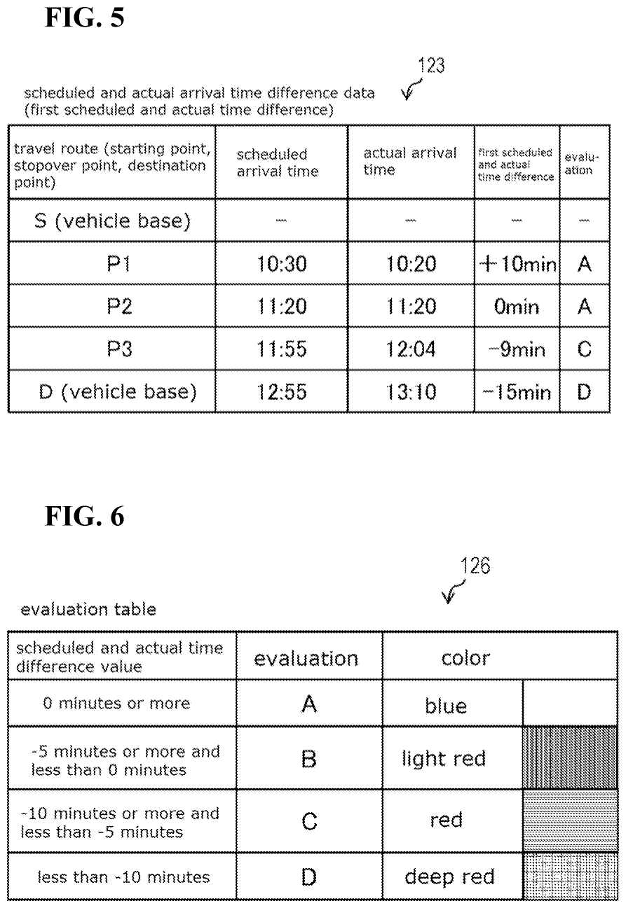

Scheduled and actual arrival time difference data 123 shown in FIG. 5 indicates the first scheduled and actual time difference, which is the difference between the scheduled arrival time included in travel plan data 121 shown in FIG. 2 and the actual arrival time included in travel record data 122 shown in FIG. 3. The first scheduled and actual time difference is calculated for each of first point P1, second point P2, third point P3, and destination point D.

As shown in FIG. 5, the scheduled and actual arrival time difference at first point P1 is +10 minutes. The scheduled and actual arrival time difference of +10 minutes indicates that vehicle 40 arrived 10 minutes earlier than the scheduled arrival time. The scheduled and actual arrival time difference at second point P2 is 0 minutes. The scheduled and actual arrival time difference of 0 minutes indicates that vehicle 40 has arrived at the scheduled arrival time. The scheduled and actual arrival time difference at third point P3 is −9 minutes. The scheduled and actual arrival time difference of −9 minutes indicates that vehicle 40 arrived 9 minutes later than the scheduled arrival time. The scheduled and actual arrival time difference at destination point D (vehicle base) is −15 minutes. The scheduled and actual arrival time difference of −15 minutes indicates that vehicle 40 arrived 15 minutes later than the scheduled arrival time.

In an embodiment, the scheduled and actual arrival time difference and other scheduled and actual time differences are evaluated by processing apparatus 110 according to an evaluation table 126 shown in FIG. 6. In an embodiment, the scheduled and actual time difference is evaluated in multiple stages. Here, the scheduled and actual time difference is evaluated in four stages. If the scheduled and actual time difference is 0 minutes or more, i.e., there is no delay, the scheduled and actual time difference is evaluated as A. If the scheduled and actual time difference is −5 minutes or more and less than 0 minutes, i.e., if the delay is within 5 minutes, the scheduled and actual time difference is evaluated as B. If the scheduled and actual time difference is −10 minutes or more and less than −5 minutes, i.e., the delay is from 10 minutes to less than 5 minutes, the evaluation of the scheduled and actual time difference is C. If the scheduled and actual time difference is less than −10 minutes, i.e., the delay is greater than 10 minutes, then the evaluation of the scheduled and actual time difference is D. Note that evaluation table 126 is stored in storage device 120.

As shown in FIG. 6, at client terminal 30, the scheduled and actual time difference of evaluation A is displayed as a blue graphical image. The scheduled and actual time difference of evaluation B is displayed as a light red graphical image. The scheduled and actual time difference of evaluation C is displayed as a red graphical image. The scheduled and actual time difference of evaluation D is displayed as a deep red graphical image. Note that the graphical image is an image for visually indicating information not by character but by a difference in color, a difference in shape, or the like. Details of the graphical image will be described later.

In FIG. 5, the evaluation of the scheduled and actual arrival time difference of first point P1 is A. Therefore, a blue graphical image is used to display the scheduled and actual arrival time difference of first point P1. The evaluation of the scheduled and actual arrival time difference of second point P2 is A. Therefore, a blue graphical image is used to display the scheduled and actual arrival time difference of second point P2. The evaluation of the scheduled and actual arrival time difference of third point P3 is C. Therefore, a red graphical image is used to display the scheduled and actual arrival time difference of third point P3. The evaluation of the scheduled and actual arrival time difference of destination point D is D. Therefore, a deep red graphical image is used to display the scheduled and actual arrival time difference of destination point D. As described above, scheduled and actual arrival time difference data 123 is configured to display a graphical image indicating the four evaluation indexes (A, B, C, and D) indicating the degree of the length of the scheduled and actual arrival time difference in different colors on client terminal 30 which is a display device.

In step S15 of FIG. 4, processing apparatus 110 calculates a second scheduled and actual time difference which is a scheduled and actual departure time difference at starting point S, first point P1, second point P2, and third point P3 included in the travel plan of vehicle 40. In step S16, processing apparatus 110 generates a scheduled and actual departure time difference data 124 indicating the calculated second scheduled and actual time difference.

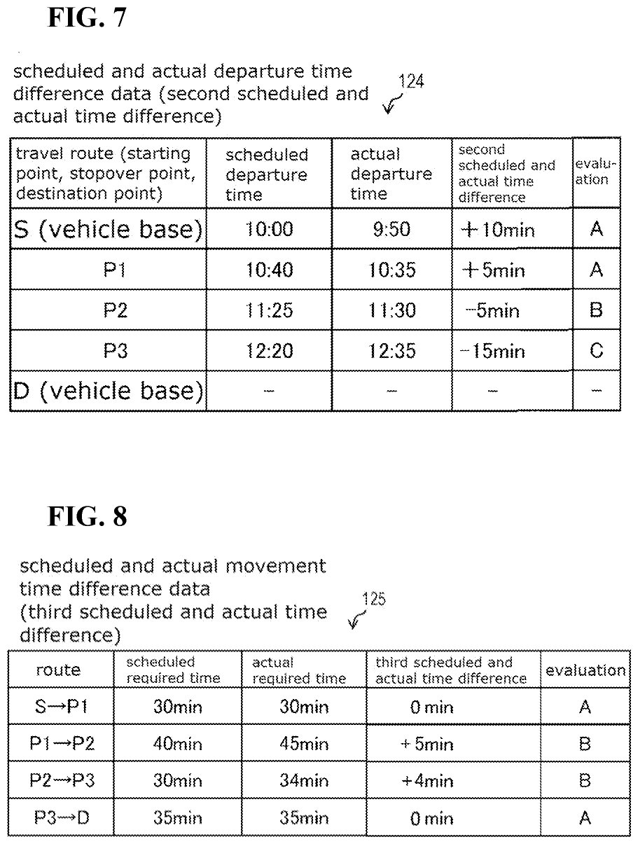

Scheduled and actual departure time difference data 124 shown in FIG. 7 indicates the second scheduled and actual time difference, which is the difference between the scheduled departure time included in travel plan data 121 shown in FIG. 2 and the actual departure time included in travel record data 122 shown in FIG. 3. The second scheduled and actual time difference is calculated for each of starting point S, first point P1, second point P2, and third point P3.

As shown in FIG. 7, the scheduled and actual departure time difference at starting point S is +10 minutes. The scheduled and actual departure time difference of +10 minutes indicates that vehicle 40 has departed 10 minutes earlier than the scheduled departure time. The scheduled and actual departure time difference at first point P1 is +5 minutes. The scheduled and actual departure time difference of +5 minutes indicates that vehicle 40 has departed 5 minutes earlier than the scheduled departure time. The scheduled and actual departure time difference at second point P2 is −5 minutes. The scheduled and actual departure time difference of −5 minutes indicates that vehicle 40 has departed 5 minutes later than the scheduled departure time. The scheduled and actual departure time difference at third point P3 is −15 minutes. The scheduled and actual departure time difference of −15 minutes indicates that vehicle 40 has departed 15 minutes later than the scheduled departure time.

In FIG. 7, the evaluation of the scheduled and actual departure time difference of starting point S is A. Therefore, a blue graphical image is used to display the scheduled and actual departure time difference of starting point S. The evaluation of the scheduled and actual departure time difference of first point P1 is A. Therefore, a blue graphical image is used to display the scheduled and actual departure time difference of first point P1. The evaluation of the scheduled and actual departure time difference of second point P2 is B. Therefore, a light red graphical image is used to display the scheduled and actual departure time difference of second point P2. The evaluation of the scheduled and actual departure time difference of third point P3 is C. Therefore, a red graphical image is used to display the scheduled and actual departure time difference of third point P3. As described above, scheduled and actual departure time difference data 124 is configured to display graphical images indicating four evaluation indices (A, B, C, and D) indicating the degree of the length of the scheduled and actual departure time difference in different colors on client terminal 30, which is a display device.

In step S17 of FIG. 4, processing apparatus 110 calculates a third scheduled and actual time difference, which is a scheduled and actual time difference of the travel time between the two points. In step S18, processing apparatus 110 generates a scheduled and actual movement time difference data 125 indicating the calculated third scheduled and actual time difference.

Scheduled and actual movement time difference data 125 shown in FIG. 8 indicates the scheduled required time determined from travel plan data 121 shown in FIG. 2, the actual required time determined from travel record data 122 shown in FIG. 3, the scheduled and actual time difference (scheduled and actual movement time difference), which is the difference between the scheduled required time and the actual required time, and an evaluation of the scheduled and actual movement time difference. The third scheduled and actual time difference and its evaluation are determined for each path. The route here includes a first route from starting point S to first point P1, a second route from first point P1 to second point P2, a third route from second point P2 to third point P3, and a fourth route from third point P3 to destination point D.

As shown in FIG. 8, the scheduled and actual movement time difference (third scheduled and actual time difference) for the first path (path from S to P1) is 0 minutes and the evaluation is A. Therefore, a blue graphical image is used to display the scheduled and actual movement time difference of the first path. The scheduled and actual movement time difference for the second path (path from P1 to P2) is −5 minutes and the evaluation is B. Therefore, a light red graphical image is used to display the scheduled and actual movement time difference of the second path. The scheduled and actual movement time difference for the third path (path from P2 to P3) is −4 minutes and the evaluation is B. Therefore, a light red graphical image is used to display the scheduled and actual movement time difference of the third path. The scheduled and actual movement time difference for the fourth path (path from P3 to D) is 0 minutes and the evaluation is A. Therefore, a blue graphical image is used to display the scheduled and actual movement time difference of the fourth path. As described above, scheduled and actual movement time difference data 125 is configured to display graphical images indicating four evaluation indexes (A, B, C, and D) indicating the degree of the length of the scheduled and actual movement time difference in different colors on client terminal 30 which is a display device.

In step S19 of FIG. 4, processing apparatus 110 generates display data including scheduled and actual arrival time difference data 123, scheduled and actual departure time difference data 124, and scheduled and actual movement time difference data 125, and transmits the generated display data to client terminal 30 functioning as a display device. In step S20, processing apparatus 110 transmits factor data 128 to client terminal 30. The transmission of factor data 128 may be performed together with the transmission of the display data, or may be performed in response to a request from client terminal 30 after the transmission of the display data.

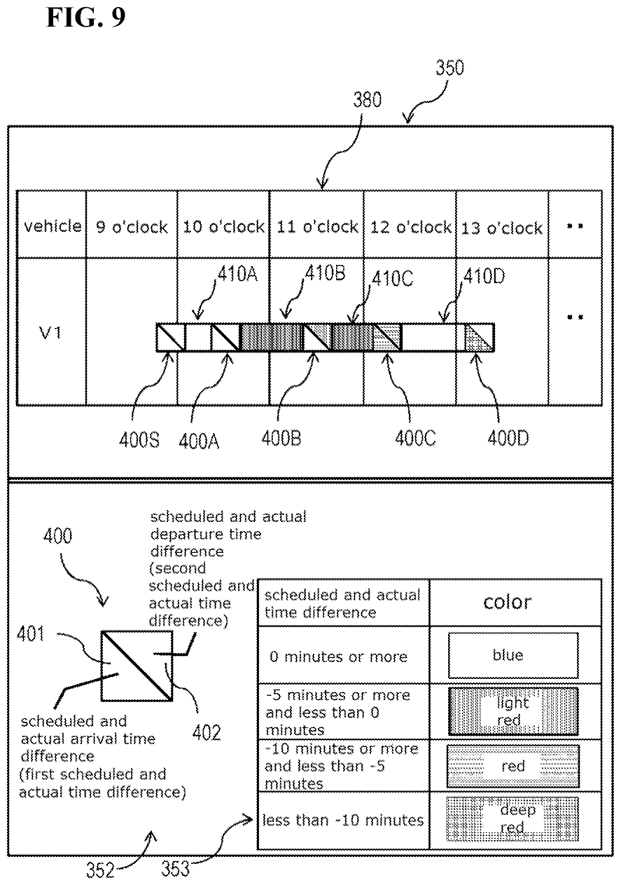

FIG. 9 shows an example of a screen 350 displayed on display 340 of client terminal 30 that has received the display data. Screen 350 is generated in client terminal 30 according to the display data.

Screen 350 shown in FIG. 9 shows the travel record with scheduled and actual time difference in a Gantt chart 380. That is, here, the display data is configured to indicate the travel record and the scheduled and actual time difference in Gantt chart 380.

Screen 350 includes Gantt chart 380 and a legend 352 for Gantt chart 380. Gantt chart 380 is configured to include point markers 400, 400S, 400A, 400B, 400C, and 400D indicating stay times at starting point S, first point P1, second point P2, third point P3, and destination point D, and links 410A, 410B, 410C, and 410D indicating required times for movement between two points in a travel record of vehicle 40 shown in V1 in FIG. 9.

Legend 352 includes a description of point marker 400 and a scheduled and actual time difference-color correspondence table 353 indicating the relationship between the length of the scheduled and actual time difference and the color. Point marker 400 in Gantt chart 380 is a screen area indicating starting point S, first point P1, second point P2, third point P3, and destination point D. As in the description of point marker 400, point marker 400 in Gantt chart 380 is a rectangular image (graphical image). Rectangular point marker 400 is divided by a line segment connecting the upper left end and the lower right end. A lower left area of rectangular point marker 400 is a first graphical image 401 indicating a scheduled and actual arrival time difference (first scheduled and actual time difference). First graphical image 401 has a color corresponding to the scheduled and actual arrival time difference (first scheduled and actual time difference) evaluations A, B, C and D. An upper right area of rectangular point marker 400 is a second graphical image 402 indicating a scheduled and actual departure time difference (second scheduled and actual time difference). Second graphical image 402 has a color corresponding to the evaluation A, B, C, and D of the scheduled and actual departure time difference (second scheduled and actual time difference).

The scheduled and actual arrival time difference (first scheduled and actual time difference) and the scheduled and actual departure time difference (second scheduled and actual time difference) are displayed in point markers 400S, 400A, 400B, 400C, and 400D, which are screen areas indicating starting point S, first point P1, second point P2, third point P3, and destination point D, so that the user can distinguish and grasp the arrival delay and the departure delay at each point.

Each of point markers 400S, 400A, 400B, 400C, and 400D has a width on the Gantt chart time axis (horizontal axis) corresponding to the length of the actual stay time at each point. Since point marker 400 has a width corresponding to the length of the actual stay time, the user can visually grasp the stay time at each point. The width of the point marker may be switched from the width corresponding to the actual stay time to the width corresponding to the scheduled stay time by a user operation.

In FIG. 9, point marker 400S indicates the scheduled and actual departure time difference at starting point S. Point marker 400A indicates a scheduled and actual arrival time difference, a scheduled and actual departure time difference, and a stay time at first point P1. Point marker 400B indicates the scheduled and actual arrival time difference, the scheduled and actual departure time difference, and the stay time at second point P2. Point marker 400C indicates the scheduled and actual arrival time difference, the scheduled and actual departure time difference, and the stay time at third point P3. Point marker 400D indicates the scheduled and actual arrival time difference at destination point D.

Links 410A, 410B, 410C, and 410D are third graphical images indicating a scheduled and actual movement time difference (third scheduled and actual time difference). The third graphical image has a color corresponding to the evaluation A, B, C, D of the scheduled and actual movement time difference (third scheduled and actual time difference). Each of links 410A, 410B, 410C, and 410D has a width on the Gantt chart time axis (horizontal axis) corresponding to the length of the actual required time for movement from the first path to the fourth path. Since links 410A, 410B, 410C, and 410D, which are the third graphical images, have widths corresponding to the lengths of the actual required times, the user can visually grasp the required times of the respective paths. Further, since the scheduled and actual time difference of the required time is indicated by the difference in color, the scheduled and actual time difference can be visually grasped. The width of the link may be switched from the width corresponding to the actual required time to the width corresponding to the scheduled required time by a user operation.

In FIG. 9, link 410A indicates the scheduled and actual movement time difference and required time for the first path (path from S to P1). Link 410B indicates the scheduled and actual movement time difference and the required time of the second path (path from P1 to P2). Link 410C indicates the scheduled and actual movement time difference and the required time of the third path (the path from P2 to P3). Link 410D indicates the scheduled and actual movement time difference and the required time of the fourth path (the path from P3 to D).

According to Gantt chart 380 of the embodiment, it is easy for the user to distinguish and grasp a delay while moving and a delay while staying at a spot. Therefore, the user can easily determine whether the cause of the delay is during movement between delivery destinations (points) or during work at the delivery destination. In addition, even in a case where a plurality of points (delivery destinations) continuously exist, it is easy for the user to grasp the tendency of delay (expansion, maintenance, or reduction).

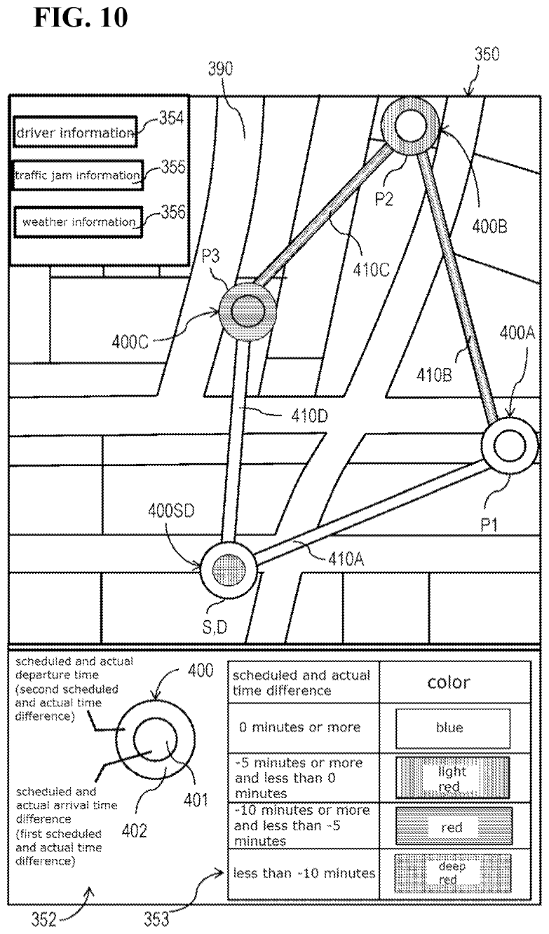

FIG. 10 shows another example of screen 350. Screen 350 shown in FIG. 10 is displayed on display 340 of client terminal 30 together with screen 350 shown in FIG. 9, or instead of screen 350 shown in FIG. 9.

Screen 350 shown in FIG. 10 includes a map indication 390 including a travel route of vehicle 40 and legend 352. Map indication 390 indicates a map in a geographical range including starting point S, first point P1, second point P2, third point P3, and destination point D included in the travel route. In screen 350 shown in FIG. 10, point markers 400SD, 400A, 400B, and 400C are arranged at the positions of starting point S, first point P1, second point P2, third point P3, and destination point D on map indication 390, respectively. On the map, point markers 400SD, 400A, 400B, and 400C are connected by linear links 410A, 410B, 410C, and 410D. In the example of FIG. 10, the display data is configured to indicate point markers 400SD, 400A, 400B, and 400C and links 410A, 410B, 410C, and 410D on the map. Note that the display data may include at least one of scheduled and actual arrival time difference data 123, scheduled and actual departure time difference data 124, and scheduled and actual movement time difference data 125, or may include various data other than these data. For example, the display data may be data for screen display including image data of a Gantt chart or a map. The device that generates the data for screen display may be processing apparatus 110 included in travel management apparatus 10 or processing apparatus 310 included in client terminal 30.

Legend 352 includes a description of point marker 400 and scheduled and actual time difference-color correspondence table 353 indicating the relationship between the length of the scheduled and actual time difference and the color. Point marker 400 in map indication 390 is a screen area indicating starting point S, first point P1, second point P2, third point P3, and destination point D.

As in the description of point marker 400 in FIG. 10, point marker 400 in map indication 390 is a circular image (graphical image). Circular point marker 400 is divided into an inner area and an outer area. An inner area of point marker 400 is first graphical image 401 indicating a scheduled and actual arrival time difference (first scheduled and actual time difference). First graphical image 401 has a color corresponding to the scheduled and actual arrival time difference (first scheduled and actual time difference) evaluations A, B, C, and D. An outer area of circular point marker 400 is second graphical image 402 indicating a scheduled and actual departure time difference. Second graphical image 402 has a color corresponding to the evaluation A, B, C, and D of the scheduled and actual departure time difference (second scheduled and actual time difference).

The scheduled and actual arrival time difference (first scheduled and actual time difference) and the scheduled and actual departure time difference (second scheduled and actual time difference) are displayed in point markers 400SD, 400A, 400B, and 400C, which are screen areas indicating starting point S, first point P1, second point P2, third point P3, and destination point D, so that the user can distinguish and grasp the arrival delay and the departure delay at each point.

In FIG. 10, point marker 400SD indicates the scheduled and actual departure time difference at the vehicle base. Point marker 400A indicates the scheduled and actual arrival time difference and the scheduled and actual departure time difference at first point P1. Point marker 400B indicates the scheduled and actual arrival time difference and the scheduled and actual departure time difference at second point P2. Point marker 400C indicates the scheduled and actual arrival time difference and the scheduled and actual departure time difference at third point P3. Point marker 400SD indicates the scheduled and actual arrival time difference at destination point D. The length of the stay time at each point may be indicated by the size of the diameter of the circular point marker.

Links 410A, 410B, 410C, and 410D are third graphical images indicating a scheduled and actual movement time difference (third scheduled and actual time difference). The third graphical image has a color corresponding to the evaluation A, B, C, and D of the scheduled and actual movement time difference (third scheduled and actual time difference). The third graphical images links 410A, 410B, 410C, and 410D indicate the scheduled and actual time difference of the required time by a difference in color, so that the user can visually grasp the scheduled and actual time difference.

According to map indication 390 of the embodiment, it is easy for the user to distinguish and grasp a delay while moving and a delay while staying at a spot. Therefore, the user can easily determine whether the cause of the delay is during movement between the delivery destinations (points) or during work at the delivery destinations. In addition, even in a case where a plurality of points (delivery destinations) continuously exist, it is easy for the user to grasp the tendency of delay (expansion, maintenance, or reduction).

In FIG. 10, link 410A indicates the scheduled and actual movement time difference of the first path (path from S to P1). Link 410B indicates the scheduled and actual movement time difference of the second path (the path from P1 to P2). Link 410C indicates the scheduled and actual movement time difference of the third path (the path from P2 to P3). Link 410D indicates the scheduled and actual movement time difference of the fourth path (path from P3 to D). The length of time required for each path may be indicated by the link width.

Screen 350 shown in FIG. 10 also displays a driver information 354, a traffic jam information 355, and a weather information 356. Driver information 354, traffic jam information 355, and weather information 356 are displayed according to factor data 128 transmitted from travel management apparatus 10. Since driver information 354, traffic jam information 355, and weather information 356 are factors that affect the travel record of vehicle 40, the user can analyze the point in more detail by referring to the point marker and the link while referring to driver information 354, traffic jam information 355, and weather information 356.

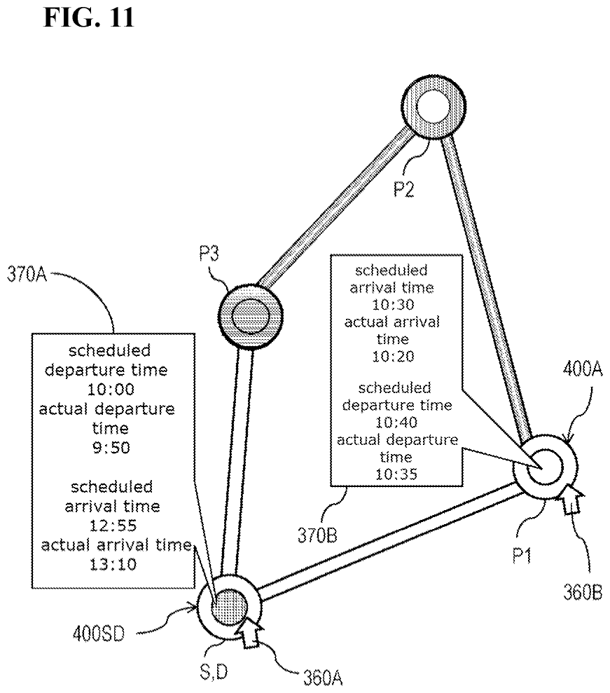

Here, it is assumed that the user places a mouse pointer 360A on point marker 400SD or clicks or taps point marker 400SD by a user operation in client terminal 30 as shown in FIG. 11. Then, a balloon 370A indicating information in point marker 400SD appears on screen 350. Balloon 370A indicates, for example, a scheduled departure time, an actual departure time, a scheduled arrival time, and an actual arrival time. The same applies to other point markers. For example, when the user places a mouse pointer 360B on point marker 400A, a balloon 370B indicating the scheduled arrival time, the actual arrival time, the scheduled departure time, and the actual departure time at first point P1 appears on screen 350. In this way, each time is displayed as a number, so that the user can grasp an accurate time.

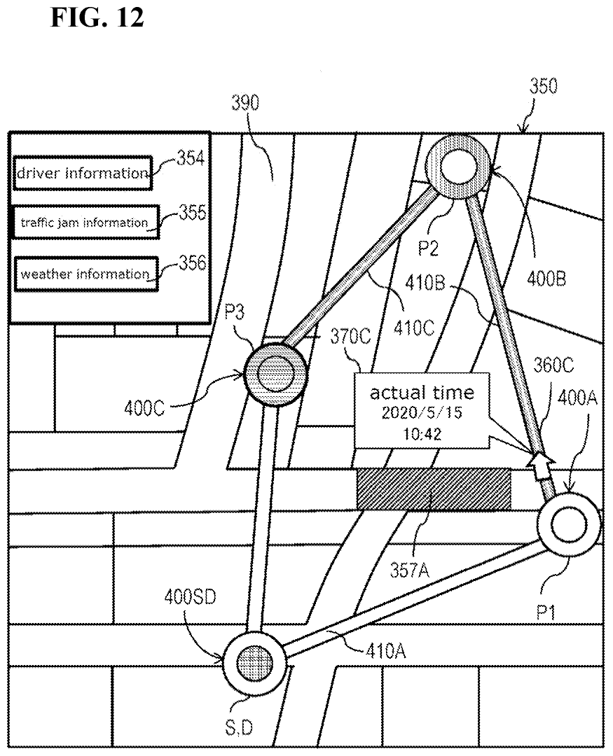

Next, it is assumed that the user places a mouse pointer 360C on any link, for example, link 410B, or clicks or taps link 410B by a user operation in client terminal 30 as shown in FIG. 12. Then, a balloon 370C indicating information at the position appears on screen 350. Balloon 370C indicates, for example, an actual time included in a time slot in which vehicle 40 has traveled the second route (route from P1 to P2) corresponding to link 410B. That is, the user operation using a mouse pointer 360 or the like is an operation for obtaining the time (designation time) included in the time slot in which vehicle 40 has moved from first point P1 to second point P2. Such a user operation is received as designation of time (designation time) by processing apparatus 110 of travel management apparatus 10. Processing apparatus 110 displays the designation time (actual time 10:42) as balloon 370C on screen 350, and generates factor data such as traffic jam information at the designation time. When the generated factor data includes traffic jam information, a traffic jam indication 357A indicating a traffic jam location is displayed on map indication 390 on screen 350 of client terminal 30. Traffic jam indication 357A is traffic jam information at time 10:42. In other words, a traffic jam indication 357 indicates traffic jam information during movement along the second route.

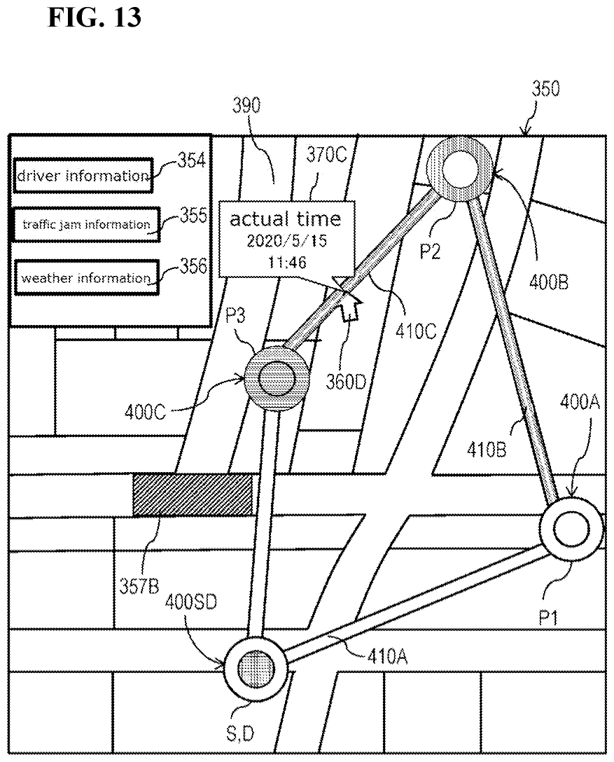

As shown in FIG. 13, when the user places a mouse pointer 360D on another link 410C, balloon 370C indicating the actual time (11:46) at that position appears on screen 350. A balloon 370D indicates an actual time included in a time slot in which vehicle 40 has traveled the third route (route from P2 to P3) corresponding to link 410C. In this case, on screen 350, a traffic jam indication 357B indicating traffic jam information at time 11:46 is displayed on screen 350.

Factor data such as traffic jam information may change depending on the time, but according to the embodiment, factor data corresponding to the designation time by the user is displayed, and thus it becomes easy for the user to analyze the relationship between the delay and the factor.

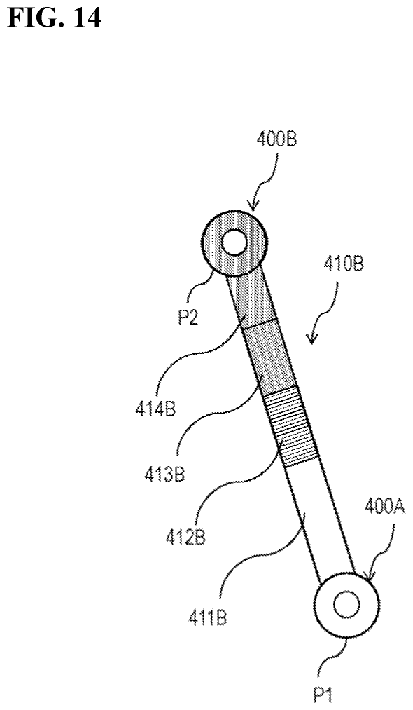

FIG. 14 shows another display example of links 410A, 410B, 410C, and 420D connecting two points. In FIG. 14, link 410B connecting first point P1 and second point P2 is shown as an example. Link 410B is divided into a plurality of subsections 411B, 412B, 413B, and 414B. Then, a scheduled and actual movement time difference is obtained for each subsection, and a color corresponding to the scheduled and actual movement time difference is displayed for each subsection. With such a display, a change in the scheduled and actual movement time difference (third scheduled and actual time difference) occurring during movement from first point P1 to second point P2 can be indicated by a color.

### ADDITIONAL NOTE

It should be understood that the embodiments disclosed herein are illustrative in all respects and are not restrictive. The scope of the present invention is defined not by the above description but by the claims, and is intended to include meanings equivalent to the claims and all modifications within the scope.

### REFERENCE SIGNS LIST

1 travel management system, 10 travel management apparatus, 12 storage device, 20 network, 30 client terminal, 40 vehicle, 110 processing apparatus, 111 travel plan creation process, 113 analysis process, 120 storage device, 121 travel plan data, 122 travel record data, 123 scheduled and actual arrival time difference data, 124 scheduled and actual departure time difference data, 125 scheduled and actual movement time difference data, 126 evaluation table, 128 factor data, 130 communication interface, 140 computer program, 310 processing apparatus, 311 travel management process, 320 storage device, 321 travel management application computer program, 330 input device, 340 display, 350 screen, 352 legend, 353 color correspondence table, 354 driver information, 355 traffic jam information, 356 weather information, 357 traffic jam indication, 357A traffic jam indication, 357B traffic jam indication, 360 mouse pointer, 360A mouse pointer, 360B mouse pointer, 360C mouse pointer, 360D mouse pointer, 370A balloon, 370B balloon, 370C balloon, 370D balloon, 380 Gantt chart, 390 map indication, 400 point marker, 400A point marker, 400B point marker, 400C point marker, 400D point marker, 400S point marker, 400SD point marker, 401 first graphical image, 402 second graphical image, 410A link, 410B link, 410C link, 410D link, 411B section, 412B section, 413B section, 414B section, 420D link, D destination point, P1 first point, P2 second point, P3 third point, S starting point.

1. A method for managing travel of a vehicle, the method comprising:
acquiring, by a processing apparatus, travel plan data of the vehicle, and travel record data including a travel record of the vehicle having traveled along a travel route included in the travel plan data;
generating, by the processing apparatus, scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point or a difference between a scheduled time at which the vehicle arrives at a destination point on the travel route and a time at which the vehicle actually arrives at the destination point;
generating, by the processing apparatus, scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point or a difference between a scheduled time at which the vehicle departs from the stopover point and a time at which the vehicle actually departs from the stopover point; and
generating display data including the scheduled and actual arrival time difference data and the scheduled and actual departure time difference data,
wherein the travel plan data includes scheduled times at which the vehicle departs from the starting point and the stopover point, and scheduled times at which the vehicle arrives at the stopover point and the destination point, and
the travel record data includes times at which the vehicle actually departs from the starting point and the stopover point, and times at which the vehicle actually arrives at the stopover point and the destination point.

2. The method according to claim 1, wherein
the scheduled and actual arrival time difference data includes a first graphical image representing the first scheduled and actual time difference without using characters or numbers,
the method comprising:
displaying the first graphical image on a screen of a display device.

3. The method according to claim 1, wherein
the scheduled and actual departure time difference data includes a second graphical image representing the second scheduled and actual time difference without using characters or numbers,
the method comprising:
displaying the second graphical image on a screen of a display device.

4. The method according to claim 2,
wherein when the first scheduled and actual time difference is a difference between a scheduled time at which the vehicle arrives at the stopover point and a time at which the vehicle actually arrives at the stopover point, the first graphical image is displayed in an area of the screen, the area of the screen showing the stopover point, and
when the first scheduled and actual time difference is a difference between a scheduled time at which the vehicle arrives at the destination point and a time at which the vehicle actually arrives at the destination point, the first graphical image is displayed in an area of the screen, the area of the screen showing the destination point.

5. The method according to claim 3,
wherein when the second scheduled and actual time difference is a difference between a scheduled time at which the vehicle departs from the starting point and a time at which the vehicle actually departs from the starting point, the second graphical image is displayed in an area of the screen, the area of the screen showing the starting point, and
when the second scheduled and actual time difference is a difference between a scheduled time at which the vehicle departs from the stopover point and a time at which the vehicle actually departs from the stopover point, the second graphical image is displayed in an area of the screen, the area of the screen showing the stopover point.

6. The method according to claim 4,
wherein the screen shows a map including the travel route.

7. The method according to claim 1,
wherein the display data further includes scheduled and actual movement time difference data indicating a scheduled and actual movement time difference, the scheduled and actual movement time difference being a difference between a scheduled time taken for the vehicle to move between two points among the starting point, the one or more stopover points on the travel route, and the destination point along the travel route and a time taken for the vehicle to actually move between the two points along the travel route.

8. The method according to claim 7,
wherein a section between the two points is divided into a plurality of subsections, and
the display data further includes, for each of the subsections, data indicating a difference between a scheduled time taken for the vehicle to move through the subsection along the travel route and a time taken for the vehicle to actually move through the subsection along the travel route.

9. The method according to claim 1, further comprising:
transmitting, by the processing apparatus, factor data to the display device, the factor data indicating a factor that causes the first scheduled and actual time difference or the second scheduled and actual time difference.

10. The method according to claim 7, further comprising:
receiving, by the processing apparatus, a designation of a time included in a time slot during which the vehicle travels; and
transmitting, by the processing apparatus, factor data to the display device, the factor data indicating a factor that causes the scheduled and actual movement time difference at the designated time.

11. An apparatus for managing travel of a vehicle, the apparatus comprising:
a memory; and
a processor configured to read a computer program stored in the memory and execute a method for managing travel of the vehicle, wherein
the method includes:
acquiring travel plan data of the vehicle, and travel record data including a travel record of the vehicle having traveled along a travel route included in the travel plan data;
generating scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point, or a difference between a scheduled time at which the vehicle arrives at a destination point on the travel route and a time at which the vehicle actually arrives at the destination point;
generating scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point, or a difference between a scheduled time at which the vehicle departs from the stopover point and a time at which the vehicle actually departs from the stopover point; and
generating display data including the scheduled and actual arrival time difference data and the scheduled and actual departure time difference data,
wherein the travel plan data includes a scheduled time at which the vehicle departs from the starting point and the stopover point, and a scheduled time at which the vehicle arrives at the stopover point and the destination point, and
the travel record data includes times at which the vehicle actually departs from the starting point and the stopover point, and times at which the vehicle actually arrives at the stopover point and the destination point.

12. A non-transitory computer-readable recording medium storing a computer program for causing a computer to execute an analysis process,
the analysis process comprising:
acquiring travel plan data of a vehicle, and travel record data including a travel record of the vehicle having traveled along a travel route included in the travel plan data;
generating scheduled and actual arrival time difference data indicating a first scheduled and actual time difference, based on the travel plan data and the travel record data, the first scheduled and actual time difference being a difference between a scheduled time at which the vehicle arrives at a stopover point on the travel route and a time at which the vehicle actually arrives at the stopover point, or a difference between a scheduled time at which the vehicle arrives at a destination point on the travel route and a time at which the vehicle actually arrives at the destination point;
generating scheduled and actual departure time difference data indicating a second scheduled and actual time difference, based on the travel plan data and the travel record data, the second scheduled and actual time difference being a difference between a scheduled time at which the vehicle departs from a starting point on the travel route and a time at which the vehicle actually departs from the starting point, or a difference between a scheduled time at which the vehicle departs from the stopover point and a time at which the vehicle actually departs from the stopover point; and
generating display data including the scheduled and actual arrival time difference data and the scheduled and actual departure time difference data,
wherein the travel plan data includes a scheduled time at which the vehicle departs from the starting point and the stopover point, and a scheduled time at which the vehicle arrives at the stopover point and the destination point, and
the travel record data includes times at which the vehicle actually departs from the starting point and the stopover point, and times at which the vehicle actually arrives at the stopover point and the destination point.
